(19) United States
(12) Patent Application Publication
(10) Pub. No.: US 2014/0255585 A1
(43) Pub. Date: Sep. 11, 2014

(54) BEVERAGE

(71) Applicant: Lanmor House, Wembley, Middlesex (GB)

(72) Inventors: Ketan Joshi, Wembley (GB); Gregory Watson, Wembley (GB); Neville Portelli, Wembley (GB)

(73) Assignee: Soft Brew Licensing Limited, Wembley, Middlesex (GB)

(21) Appl. No.: 14/353,255

(22) PCT Filed: Oct. 22, 2012
(86) PCT No.: PCT/GB2012/052620

§ 371 Date: Apr. 21, 2014

(30) Foreign Application Priority Data
Oct. 21, 2011 (GB) 1118169.0

(51) Int. Cl. A23L 2/38; A23L 2/54

(52) U.S. Cl. CPC A23L 2/38; A23L 2/54
USPC 426/598; 426/599; 426/600

(57) ABSTRACT

There is provided a non-fermented carbonated beverage comprising: an aqueous fruit or vegetable sugar-containing extract, a flavouring agent and a foam stabiliser, wherein, if the aqueous fruit or vegetable sugar-containing extract is produced from malted grain, the extract is not a lager wort. Also provided is a non-fermented concentrated beverage formulation comprising a concentrated aqueous fruit or vegetable sugar-containing extract; a flavouring agent; and a foam stabiliser, wherein the concentrated beverage formulation can be diluted with water and carbonated to form a non-fermented carbonated beverage.

### FIELD OF THE INVENTION

The present invention relates to a beverage. In particular, though not exclusively, it relates to a non-fermented carbonated beverage which is alcohol free and which is intended to provide the taste and mouth-feel of a fermented beverage.

### BACKGROUND TO THE INVENTION

Non-alcoholic beverages which mimic fermented beverages have become popular because they can provide the taste and mouth-feel of a fermented beverage without the negative effects of alcohol. Such beverages are also popular where cultural considerations prohibit the consumption of alcoholic beverages.

Generally, non-alcoholic beverages are made by removing the alcohol from a fermented beverage. Very few non-alcoholic beverages, which are intended to be non-alcoholic versions of a fermented beverage, are made without using fermentation. For example, many non-alcoholic lagers are made by simply removing the alcohol from the standard fermented alcoholic version. This can result in lagers which still contain a small amount of alcohol even though they may be described as non-alcoholic. In the United Kingdom, a beverage having less than 0.05% ABV can legally be described as alcohol-free. In other parts of the European Union, a beverage labelled as “alcohol-free” may contain up to 0.5% ABV.

WO 2008/083718 discloses a beverage kit and method for producing a non-fermented malt beverage. In WO 2008/083718, the non-fermented malt beverage is made using a wort that is produced from malt and rice. Such a wort is typical known as a ‘lager wort’ as the wort contains a high proportion of extracts from rice.

### SUMMARY OF THE INVENTION

In a first aspect, the present invention provides a non-fermented carbonated beverage comprising an aqueous fruit or vegetable sugar-containing extract, a flavouring agent and a foam stabiliser, wherein, if the aqueous fruit or vegetable sugar-containing extract is produced from malted grain, the extract is not a lager wort.

The beverage of the invention provides a mouth-feel and a foam ‘head’ similar to that of a fermented beverage such as beer, but without the presence of alcohol in the beverage. In particular, the carbonation of the beverage means that when it is poured into a glass, the carbon dioxide gas is released and bubbles through the beverage creating a frothy head. The foam stabiliser then stabilises the frothy head so that it remains at the top of the beverage in the glass rather than dissipating relatively quickly. This mimics the properties of a fermented beverage such as beer so that the beverage of the invention appears to be more like a fermented beverage and appeals to users wanting a drink which is similar to a fermented beverage but does not contain alcohol.

The beverage does not contain alcohol. In the context of the invention, this means that there is no alcohol present in the beverage whatsoever. It does not mean that a low level of alcohol can be present in the beverage as with some definitions of the terms “non-alcoholic” and “alcohol-free”.

The reason that the beverage does not contain any alcohol is that it is not fermented. Fermentation is the conversion of carbohydrates to alcohol and carbon dioxide using yeasts, bacteria, or a combination thereof, under anaerobic conditions. When the beverage of the invention is produced, the aqueous fruit or vegetable sugar-containing extract, e.g. a bitter wort, does not have any yeast or bacteria added to it to allow fermentation.

The beverage contains an aqueous fruit or vegetable sugar-containing extract. This extract is typically an aqueous solution that contains sugars which have been extracted from the fruit or vegetable into the aqueous solution. For example, fleshy fruit (e.g. grapes) or vegetables may be crushed to produce an aqueous juice which would contain sugar from the fruit or vegetable. This juice may or may not be diluted with water. This juice would be an aqueous fruit or vegetable sugar-containing extract as it contains sugars from the fruit or vegetable. Alternatively, the fruit or vegetable may be steeped or mashed in water. This allows the sugars in the fruit or vegetable to be released into the water to produce an aqueous extract which contains the sugar of the fruit or vegetable, i.e. an aqueous fruit or vegetable sugar-containing extract.

The term ‘sugar’ includes monosaccharides, disaccharides, oligosaccharides and polysaccharides that are found in fruit and vegetables. This includes, for example, starch, maltose, sucrose, glucose and fructose.

The fruit or vegetable may be any suitable fruit or vegetable which contains sugars which can be extracted into an aqueous solution. The term ‘fruit’ includes the seeds and/or the fleshy structure that normally surrounds and carries/encases the seeds. Suitable fruits and vegetables include but are not limited to: malted grain such as malted barley, malted wheat and malted rye; citrus fruit such as orange, lemon, lime, grapefruit, tangerine, satsuma and clementine; tropical fruit such as pineapple, mango and passion fruit; berries such as strawberry, raspberry, blueberry, blackberry and cranberry; superfruits such as acai, goji, maca, mangosteen, noni and pomegranate; and other fruits such as grape, apple, pear and tomato.

In one embodiment, the beverage is a malt beverage. This means that the beverage contains an aqueous sugar-containing extract which contains sugars from malt. This sugar-containing extract is known as ‘wort’ in the brewing industry. In other words, the aqueous fruit or vegetable sugar-containing extract comprises sugars from malt.

In part, it is the extract of malt that helps to give the beverage a suitable mouth-feel.

Malt is germinated cereal grains which have been dried in a process known as “malting”. The grains are made to germinate by soaking in water, and are then halted from germinating further by drying with hot air. Malting grains develops the enzymes required to modify the grains' starches into sugars, including monosaccharides such as glucose or fructose, and disaccharides, such as sucrose or maltose.

The malted grains in the malt may be selected from malted barley, malted wheat and malted rye. The malt may contain one or more of these malted grains. In one embodiment, the aqueous fruit or vegetable sugar-containing extract comprises sugars from malted barley. Optionally, the aqueous fruit or vegetable sugar-containing extract may also comprise sugars from malted wheat and/or rye.

The “mash ingredients” are the ingredients used to make a wort. These generally include malted grains and optionally may also include other adjuncts. The major component of the malted grains is normally malted barley. The process for making wort from mash ingredients is well known in the brewing industry.

The amount of sugar in the wort is measured in Original Gravity (OG). This depends on the amount of water added, the amount of mash ingredients, and time and temperature for boiling. Preferably, the wort has an OG of between about 1.045 and about 1.085. More preferably, the wort has an OG of between about 1.045 and about 1.075 or between about 1.05 and about 1.075. Even more preferably, the wort has an OG of between about 1.055 and about 1.075. More preferably still, the wort has an OG of about 1.065. When the wort is produced the ratio of mash ingredients to water may be between 10-40% solids to water by weight.

The aqueous extract which contains sugars from malt (i.e. wort) is preferably a bitter wort. A “bitter wort” is a wort which contains a relatively high level of extracts (including sugars) from malted grains (e.g. malted barley, malted wheat and malted rye) and a relatively low level of extracts (e.g. starch) from other adjuncts such as unmalted grains. This results from the mash ingredients used to make the bitter wort having a relatively high percentage of malted ingredients. For example, the percentage of malted grains may be about 80% or more of the total mash ingredients used to make the bitter wort. In some embodiments, the percentage of malted barley may be about 80% or more of the total mash ingredients used to make the bitter wort. In a particular embodiment, the percentage of malted barley may be between about 80% and about 85% of the total mash ingredients used to make the bitter wort. In addition, a bitter wort may be produced using malt which has been subjected to a roasting step.

In the beverage of the invention, if the aqueous fruit or vegetable sugar-containing extract is produced from malted grain, the extract is not a lager wort. A “lager wort” is a wort which contains a relatively low level of extracts (including sugars) from malted grains (e.g. malted barley, malted wheat and malted rye) and a relatively high level of extracts (e.g. starch) from other adjuncts such as unmalted grains. This results from the mash ingredients used to make the lager wort having a relatively low percentage of malted ingredients. Adjuncts are often used in lager making to introduce a large quantity of sugar, and thereby increase the ABV of the lager. In a lager wort, the percentage of malted grains tends to be less than about 80% of the total mash ingredients used to make the lager wort. The majority of the rest of the mash ingredients will generally be adjuncts such as rice, corn, rye, oats, barley and wheat. The percentage of malted grains may be less than about 75% of the total mash ingredients used to make the lager wort. In further particular lager worts, the percentage of malted grains may be less than about 70%, less than about 65%, less than about 60%, less than about 55%, or less than about 50% of the total mash ingredients used to make the lager wort. In particular, it is the percentage of malted barley which tends to be lower in larger wort compared to bitter wort. In a lager wort, the percentage of malted barley tends to be less than about 80% of the total mash ingredients used to make the lager wort. The percentage of malted barley may be less than about 75% of the total mash ingredients used to make the lager wort. In further particular lager worts, the percentage of malted barley may be less than about 70%, less than about 65%, less than about 60%, less than about 55%, or less than about 50% of the total mash ingredients used to make the lager wort.

The use of a wort is preferable as it provides the beverage with flavours which are associated with a fermented beverage. These wort flavours are particularly appealing as they cause a drinker to consider the beverage of the invention to be relatively similar to a fermented beverage. Where a wort is used, a bitter wort is preferable to a lager wort as a bitter wort provides the beverage with more flavour.

In particular embodiments, the aqueous fruit or vegetable sugar-containing extract may comprise between about 10% and about 50% by volume of the beverage. In further embodiments, the aqueous fruit or vegetable sugar-containing extract may comprise between about 10% and about 40%, between about 10% and about 30% or between about 15% and about 25% by volume of the beverage.

The beverage may be flavoured with an extract from hops. In some embodiments, the aqueous fruit or vegetable sugar-containing extract is flavoured with an extract from hops. In particular, when the aqueous fruit or vegetable sugar-containing extract is a bitter wort, the bitter wort may be flavoured with an extract from hops. This is generally done by adding the hops to the wort and then boiling the wort for a period of time so that the hop flavours are released into the wort. This process is well known in the brewing industry. For example, an extract from hops may be added so that the beverage has an alpha acid content of 4-10%. This may be achieved by adding hops to the beverage at about 0.15 Kg/hectolitre of beverage.

The beverage comprises a flavouring agent. The flavouring agent may be an extract or a concentrate. Suitable flavouring agents include fruit juice, herbs, spices and flowers. For example, the fruit can be a citrus fruit such as orange, lemon, lime, grapefruit, tangerine, satsuma and clementine; a tropical fruit such as pineapple, mango and passion fruit; a berry such as strawberry, raspberry, blueberry, blackberry and cranberry; a superfruit such as acai, goji, maca, mangosteen, noni and pomegranate; and other fruits such as grape, apple, pear, tomato and blackcurant. The spice may be ginger or cinnamon. The flower may be elderflower. In one embodiment, the flavouring agent may comprise a fruit juice, or an extract or concentrate thereof. The fruit juice, or extract or concentrate thereof, may be selected from orange, lemon, lime, apple, and/or blackcurrant. In other embodiments, the beverage may comprise a plurality of flavouring agents. Further, the flavouring agent may comprise a plurality of fruit juices, or extracts or concentrates thereof. Preferably, the flavouring agent is a naturally occurring flavouring agent which is suitable for human consumption.

Where the flavouring agent is added as a liquid, the flavouring agent may comprise between about 2% and about 40% by volume of the beverage. In further embodiments, the flavouring agent may comprise between about 2% and about 40%, between about 2% and about 30%, between about 2% and about 25% or between about 5% and about 25% by volume of the beverage.

If the flavouring agent is added as a concentrate, extract or powder, the amount that is added will depend on the amount of liquid that is required in order to obtain the desired flavour concentrations.

Preferably, the flavouring agent is in liquid form such as a fruit juice, concentrate or liquid extract. This allows the beverage to be produced more easily without the need for handling and dissolving powders in the beverage.

The beverage comprises a foam stabiliser. The carbonation of the beverage helps to produce a head when the beverage is poured into a glass. The foam stabiliser helps to ensure that the head remains on the beverage for a substantial amount of time (i.e. more than a few seconds). Preferably, the head should remain on the beverage for at least about 2 minutes. More preferably, the head should remain on the beverage for at least about 3, at least about 4, at least about 5, at least about 6, at least about 7, at least about 8, at least about 9, at least about 10, at least about 12, at least about 14, at least about 16, at least about 18 or at least about 20 minutes. This helps to give the beverage its similarity to a fermented beverage.

The foam stabiliser can be any suitable foam stabiliser. The foam stabiliser may be a thickening agent. The thickening agent is a compound which is generally regarded as safe in the food and beverage industries, and will typically comprise a hydrophilic polymeric ingredient, such as a polysaccharide. The thickening agent may be any suitable thickening agent such as a gum, acacia, modified starch, gelatin or pactin. Preferably, the thickening agent is a gum such as gum arabic or xanthan gum. In one embodiment, the foam stabiliser is gum arabic.

It is necessary to add a foam stabiliser as the aqueous fruit or vegetable sugar-containing extract (in particular, a wort) will not contain a foam stabiliser to allow the beverage to retain a head for a substantial amount of time.

The foam stabiliser should be present at a sufficient level to allow the beverage to retain a head for a substantial amount of time. In some embodiments, the foam stabiliser may be present at between about 0.5% and about 5% by weight relative to the beverage. In other embodiments, the foam stabiliser is present at between about 0.5% and about 4% by weight. Further, in particular embodiments, the foam stabiliser is present at between about 0.5% and about 3% by weight. The foam stabiliser may be present at between about 0.5% and about 2% by weight. The foam stabiliser can be present at between about 0.5% and about 1.5% by weight. In some embodiments, the foam stabiliser is present at about 1% by weight.

The beverage is carbonated. This helps to produce the foam head when the beverage is poured into a glass. Preferably, the beverage is carbonated so that it contains 100% to 500% by volume of carbon dioxide. This means that in 100 ml of beverage, between 100 ml and 500 ml of carbon dioxide is dissolved. The beverage may be carbonated so that it contains 100% to 400% by volume of carbon dioxide. Further, the beverage can be carbonated so that it contains 200% to 400% by volume of carbon dioxide. In some embodiments, the beverage is carbonated so that it contains 250% to 350% by volume of carbon dioxide. In particular embodiments, the beverage is carbonated so that it contains about 300% by volume of carbon dioxide.

The beverage may also comprise a foaming agent. This is an agent which helps to produce a foam head when the beverage is poured into a glass. This works in combination with the carbonation of the beverage to produce a head. This helps to ensure that the foam head that is produced is relatively thick. The foaming agent may be a surfactant. The surfactant may be any suitable surfactant which is generally regarded as safe in the food and beverage industries, e.g. quillaia extract.

The beverage may comprise an acidity regulator. This may be any acid buffer such as sodium citrate, citric acid or ascorbic acid. In one embodiment, the acidity regulator is ascorbic acid. The acidity regulator may regulate the acidity of the beverage to a pH of 2-5. Preferably, the pH is regulated to 3-4.

The beverage may comprise an antioxidant. Suitable antioxidants include ascorbic acid.

The beverage may comprise sugar in addition to that provided by the fruit or vegetable sugar-containing extract. This may be glucose, fructose or sucrose.

In some embodiments, the beverage may comprise malt extract such as barley malt extract. The amount of malt extract added will depend on the desired taste of the beverage.

The beverage preferably comprises water. The beverage may contain between about 60% and about 90% water by volume.

Obviously, all the components of the beverage must be suitable for human consumption in the quantities contained in the beverage. Any ingredients or compounds which are not suitable for human consumption should not be used in the beverage and the claims are not intended to cover such ingredients or compounds.

In a particular embodiment, there is provided a non-fermented carbonated malt beverage comprising a bitter wort, a flavouring agent and a foam stabiliser, wherein the bitter wort comprises between about 10% and about 30% by volume of the beverage, and the flavouring agent comprises between about 2% and about 25% by volume of the beverage and comprises a fruit juice or an extract or concentrate thereof, and wherein the bitter wort is flavoured with an extract from hops.

In a further aspect, the invention provides a method for making a non-fermented carbonated beverage, the method comprising:
mixing an aqueous fruit or vegetable sugar-containing extract; a flavouring agent; and a foam stabiliser to form the beverage;
holding the beverage at a temperature of between 0° C. and 5° C. to allow solid components to settle out so that they can be removed; and
carbonating the beverage to form a non-fermented carbonated beverage.

Holding the beverage at low temperature allows solid components to settle so that they can be removed. This helps to produce a clearer beverage which is more appealing to a consumer. This avoids the need to filter the beverage. Filtration can result in important components being removed from the beverage. In particular, components which provide a suitable mouth feel can be removed by filtration.

The beverage may be held for between 3 hours and 24 hours. In some embodiments, the beverage may be held for between 6 and 20 hours. In other embodiments, the beverage may be held for between 8 and 16 hours.

The method is preferably carried out at a temperature of between 0° C. and 30° C. In particular, the mixing step is preferably carried out at a temperature of between 0° C. and 30° C. In effect, this means that the beverage is not heated whilst it is produced. In some embodiments, the mixing step is carried out at a temperature of between 0° C. and 20° C. This means that volatile components of the beverage that are important for providing the flavour are not lost. This is especially important when using wort.

If a wort is used in the beverage, a skilled person will understand that elevated temperatures are used in the production of the wort. However, once produced, the wort is cooled before being used in the method and is not subsequently heated.

The method described above may include mixing with the other components to form the beverage one or more components selected from a foaming agent, an acidity regulator, an antioxidant, malt extract or any of the other components described above with regard to the beverage.

In another aspect, the invention provides a kit for making a non-fermented concentrated beverage formulation, the kit comprising:
a concentrated aqueous fruit or vegetable sugar-containing extract; a flavouring agent; and a foam stabiliser,
wherein the concentrated extract, the flavouring agent and the foam stabiliser can be mixed together to form a concentrated beverage formulation which can be diluted with water and carbonated to form a non-fermented carbonated beverage.

The skilled person will realise that the description and preferred features relating to the beverage of the invention are equally applicable to the kit of the invention. Therefore, features of the beverage may also be features of the kit where relevant, taking into account possible differences due to the concentrated beverage formulation and subsequent dilution that takes place.

The concentrated aqueous fruit or vegetable sugar-containing extract is an aqueous fruit or vegetable sugar-containing extract, as described above, which has had some of the water removed to make it more concentrated than it would otherwise be. The water can be removed in any suitable way. In some embodiments, the water may be removed by reverse osmosis. Alternatively, if water is used to make the extract, for example in the case of worts, less water can be used but with the same quantity of fruit or vegetable so that a more concentrated extract is produced than would normally be produced for preparing the beverage of the invention.

In some embodiments, the concentrated aqueous fruit or vegetable sugar-containing extract is a concentrated wort such as a concentrated lager wort or a concentrated bitter wort. Preferably, the concentrated wort is a concentrated bitter wort. Preferably, the concentrated wort is not a concentrated lager wort. Concentrated wort is more stable than normal wort as it spoils less quickly. Further, it is easier to transport as it takes up less volume and is lighter. Further, it can be produced in a microbrewery giving better geographical flexibility.

The kit may also comprise a foaming agent.

The kit may further comprise an acidity regulator.

The kit may comprise an antioxidant.

In some embodiments, the acidity regulator and antioxidant are the same compound. For example, ascorbic acid may act as an acidity regulator and also as an antioxidant. In other embodiments, the acidity regulator and antioxidant may be different compounds.

In particular embodiments, the kit also comprises a tracer which can be added to the mixture. This allows, amongst other things, the dilution of the concentrated beverage formulation to be monitored. The tracer may be any compound which can be dissolved in the sugar-containing extract or the flavouring agents (where aqueous), and which can subsequently be detected, and preferably quantified, using known analytical techniques (e.g. LC-MS, GC-MS, HPLC, etc.).

In another aspect, the invention provides a non-fermented concentrated beverage formulation comprising a concentrated aqueous fruit or vegetable sugar-containing extract; a flavouring agent; and a foam stabiliser,
wherein the concentrated beverage formulation can be diluted with water and carbonated to form a non-fermented carbonated beverage.

The concentrated beverage may also comprise a foaming agent.

The concentrated beverage formulation may also comprise an acidity regulator and/or an antioxidant.

Further possible features of the concentrated beverage formulation are as discussed above with reference to the kit and the beverage.

In a further aspect, the invention provides a method for making a non-fermented concentrated beverage formulation, the method comprising:
mixing a concentrated aqueous fruit or vegetable sugar-containing extract; a flavouring agent; and a foam stabiliser to form the non-fermented concentrated beverage formulation.

The method may further comprise diluting the non-fermented concentrated beverage formulation with water to form a non-fermented beverage.

Further, The method may further comprise carbonating the concentrated beverage formulation. Preferably, the method comprises carbonating the beverage following the dilution with water.

In effect, the method would be for making a non-fermented carbonated beverage, the method comprising:

mixing a concentrated aqueous fruit or vegetable sugar-containing extract; a flavouring agent; and a foam stabiliser to form a non-fermented concentrated beverage formulation;
diluting the concentrated beverage formulation with water to form a non-fermented beverage; and
carbonating the non-fermented beverage to form a non-fermented carbonated beverage.

In the methods described above, the concentrated aqueous fruit or vegetable sugar-containing extract may be a concentrated wort such as a concentrated lager wort or a concentrated bitter wort. Preferably, the concentrated aqueous fruit or vegetable sugar-containing extract is a concentrated bitter wort. Preferably, the concentrated aqueous fruit or vegetable sugar-containing extract is not a concentrated lager wort.

Further, the methods described above may include mixing with the other components to form the concentrated beverage formulation one or more components selected from a foaming agent, an acidity regulator, an antioxidant, malt extract or any of the other components described above with regard to the beverage.

In another aspect, the invention provides a non-fermented concentrated aqueous fruit or vegetable sugar-containing extract also comprising an acidity regulator and/or a foam stabiliser. Preferably, the concentrated aqueous fruit or vegetable sugar-containing extract is a concentrated wort such as a concentrated lager wort or a concentrated bitter wort. Preferably, the concentrated wort is a concentrated bitter wort. Preferably, the concentrated wort is not a concentrated lager wort.

The concentrated aqueous fruit or vegetable sugar-containing extract may comprise an acidity regulator. This is to keep the pH of the extract at a level which reduces or prevents bacterial growth, thereby preventing spoilage of the extract. This is a pH of less than 3.

In one embodiment, the foam stabiliser is a thickening agent.

The concentrated aqueous fruit or vegetable sugar-containing extract may comprise an antioxidant to stop the extract becoming oxidised, thereby affecting the taste of the extract.

The concentrated aqueous fruit or vegetable sugar-containing extract may also comprise further components as described above with reference to the beverage such as a foaming agent.

### DETAILED DESCRIPTION OF THE INVENTION

The Invention will now be described in detail by way of example only with reference to the figures in which:

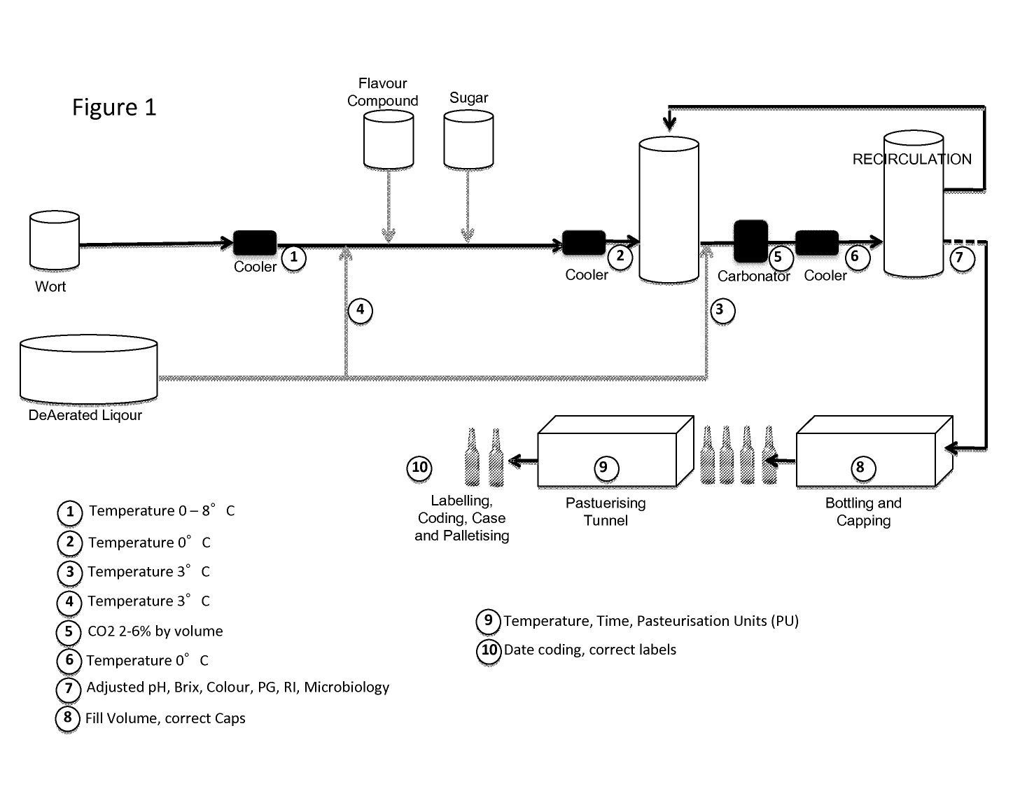

FIG. 1 is a flow chart showing a process for producing the beverage of the invention.

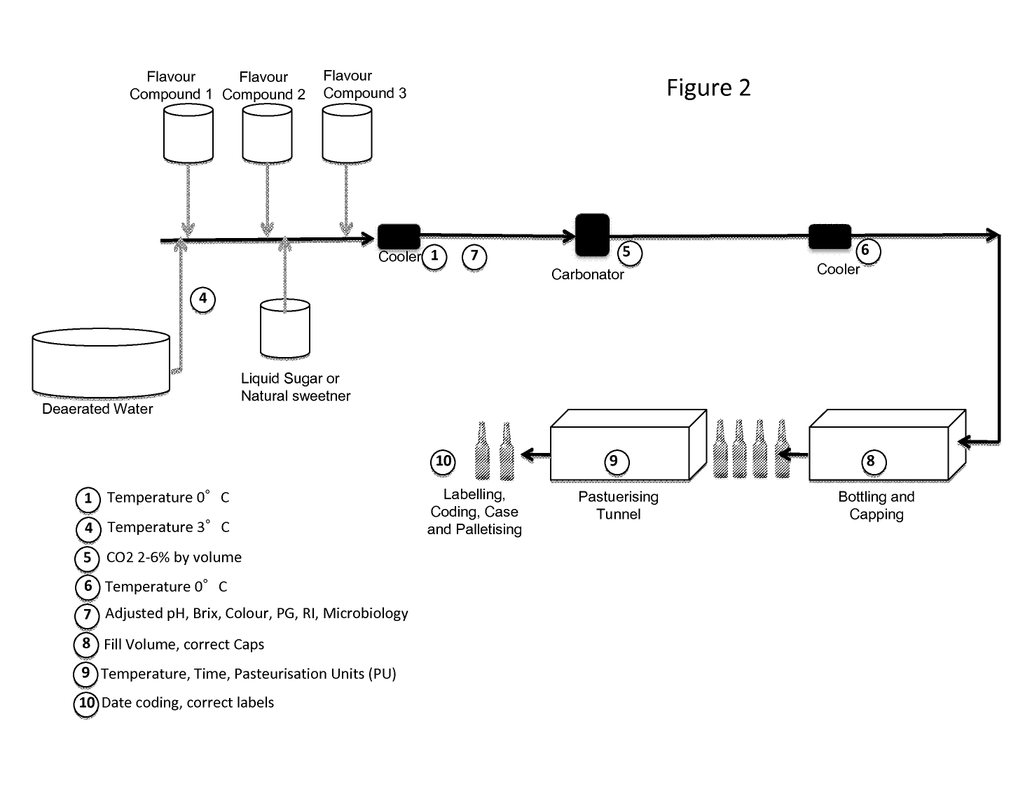

FIG. 2 is a flow chart showing a process for producing the beverage of the invention from a concentrated beverage formulation.

Process for Making a Beverage

The following description is one way of making a beverage according to the invention. However, a skilled person will appreciate that other processes are also suitable, in particular, for other embodiments of the invention not specifically described below.

Generally, the process comprises the following steps:

1) obtaining a bitter wort from ground malt and hops;
2) removing solid components from the bitter wort;
3) adding flavouring agents, stabilising agents, sweetening agents, foaming agents and/or other components.

FIG. 1 is a flow chart showing the various steps which can be used in the production of the beverage.

The quantities, ratios and quality of each ingredient used in this process may vary from brewery to brewery.

Initially, malt is passed through a mill where it is ground into grist. Grist is mixed with hot water to form a mash in a Mash Tun. The malt starch breaks down into sugars and forms a sweet wort. This wort is separated from the mash solids as it is run off from the Mash Tun transferring to a wort kettle. In the wort kettle, the wort is boiled and hops are added for additional flavour and bitterness. This produces a bitter wort.

Referring now to FIG. 1, the bitter wort is cooled. Solid (in the form of a powder) sweetening agents (e.g. sugar) and flavouring compounds are added to the wort. Deaerated liquor may also be added. The composition is then cooled. Once cooled, the composition may be held at about 0° C. to 5° C. This allows and solid components to settle so that they can be removed. This helps to produce a clearer beverage. The composition may be held for between 3 hours and 24 hours. The composition is then carbonated. Multiple carbonation steps may take place and additional deaerated liquor may be added. Once the composition has the desired characteristics, it is then bottled before being pasteurised.

Process for Making a Concentrated Beverage Formulation

A concentrated extract, e.g. a concentrated wort, is pumped into a vessel. A flavour compound, sugar and any other ingredients are added to the extract and stirred until dissolved. This gives the concentrated beverage formulation.

In order to make a beverage, still water is added to this formulation in a vessel and gently stirred until mixed thoroughly. A sample of this mix is analysed and water added to the correct level to give the desired mix concentration. The mix is pumped to the bottling line (or PET line or canning line) with CO₂ being added inline to carbonate the liquid prior to filling.

Process for Making a Concentrated Extract Such As a Wort

A blend of malted barley, wheat, and hops is ground into a powder and added to a predetermined amount of water at a ratio of about 1 kg of powder to 4 litres of water (The water ratio may be between 3 and 10 litres, i.e. 1 kg of powder to 3-10 litres of water). This semi liquid mixture is placed in a closed jacketed vessel and heated to 85° C. whilst gentle stirring to avoid powder clumping. The mix is heated and held for between 3-10 hours (length of time determines the colour and “beer taste” of the final product).

Once the predetermined level of colour and taste is reached, the mix is passed over a Thin Film evaporator to concentrate the mix by evaporating the water off. The concentrated mix is cooled and aseptically packed into airtight container for storage until used. The evaporated water is condensed, collected and analysed to determine the volatile flavour and taste notes which can be added to the final product during the production stage.

1. A non-fermented carbonated beverage comprising:
a bitter wort, a fruit or vegetable juice, and a foam stabiliser,
wherein, the bitter wort is made using 80% or more malted barley, wherein the foam stabiliser causes a frothy head to remain on the beverage for at least two minutes when poured in a glass, and wherein the beverage contains no alcohol.

2. The beverage of claim 1, wherein the beverage comprises a bitter wort, a fruit juice, and a foam stabiliser.

3. (canceled)

4. The beverage of claim 1, wherein the beverage is carbonated so that it contains 200 ml to 400 ml of dissolved carbon dioxide per 100 ml of beverage.

5. (canceled)

6. The beverage of claim 1, wherein the bitter wort comprises between about 10% and about 30% by volume of the beverage.

7. The beverage of claim 1, wherein the beverage is flavoured with an extract from hops.

8. (canceled)

9. (canceled)

10. The beverage of claim 1, wherein the beverage comprises a fruit juice and the fruit juice comprises between about 2% and about 20% by volume of the beverage.

11. The beverage of claim 1, wherein the foam stabiliser is a gum such as gum arabic or xanthan gum.

12. The beverage of claim 1, further comprising a foaming agent.

13. The beverage of claim 12, wherein the foaming agent is a surfactant such as a quillaia extract.

14. The beverage of claim 1, further comprising an acidity regulator to regulate the acidity of the beverage to a pH of 2-5.

15. (canceled)

16. The non-fermented carbonated beverage of claim 1 comprising a bitter wort, a fruit juice, a foam stabiliser and a foaming agent, wherein the bitter wort comprises between about 10% and about 30% by volume of the beverage, and the fruit juice comprises between about 2% and about 25% by volume of the beverage, wherein the beverage is flavoured with an extract from hops, wherein the beverage contains 200 ml to 400 ml dissolved carbon dioxide per 100 ml of beverage, and wherein the foam stabiliser is a gum and is present at between about 0.5% and about 2% by weight relative to the beverage.

17. A method for making a non-fermented carbonated beverage according to claim 1, the method comprising:
mixing a bitter wort; a fruit or vegetable juice; and a foam stabiliser to form the beverage, wherein the bitter wort is made using 80% or more malted barley, and wherein the foam stabiliser causes a frothy head to remain on the beverage for at least 2 minutes when poured in a glass;
holding the beverage at a temperature of between 0° C. and 5° C. for between 3 hours and 24 hours to allow solid components to settle out:
removing the settled solid components from the beverage; and
carbonating the beverage to form a non-fermented carbonated beverage.

18. (canceled)

19. The method of claim 17, wherein the beverage is held for between 8 and 16 hours.

20. The method of claim 17, wherein the beverage is not filtered.

21. (canceled)

22. (canceled)

23. The method of claim 17, further comprising mixing a foaming agent with the bitter wort; the fruit or vegetable juice; and the foam stabiliser to form the non-fermented beverage formulation.

24. A kit for making a non-fermented concentrated beverage formulation, the kit comprising:
a concentrated bitter wort; a fruit or vegetable juice; and a foam stabiliser, wherein the concentrated bitter wort is made using 80% or more malted barley, and wherein the foam stabiliser causes a frothy head to remain on the beverage for at least 2 minutes when poured in a glass,
wherein the concentrated bitter wort, the fruit or vegetable juice, and the foam stabiliser can be mixed together to form a concentrated beverage formulation which can be diluted with water and carbonated to form the non-fermented carbonated beverage of claim 1.

25. (canceled)

26. (canceled)

27. The kit of claim 24, further comprising one or more components selected from a foaming agent, an acidity regulator, an antioxidant, ascorbic acid, and a tracer.

28. (canceled)

29. (canceled)

30. (canceled)

31. (canceled)

32. A non-fermented concentrated beverage formulation comprising a concentrated bitter wort; a fruit or vegetable juice; and a foam stabiliser, wherein the concentrated bitter wort is made using 80% or more malted barley, and wherein the foam stabiliser causes a frothy head to remain on the beverage for at least 2 minutes when poured in a glass,
wherein the concentrated beverage formulation can be diluted with water and carbonated to form the non-fermented carbonated beverage of claim 1.

33. (canceled)

34. (canceled)

35. The formulation of claim 32, further comprising one or more components selected from a foaming agent, an acidity regulator, an antioxidant, ascorbic acid, and a tracer.

36. (canceled)

37. (canceled)

38. (canceled)

39. (canceled)

40. A method of making a non-fermented concentrated beverage formulation according to claim 32, the method comprising:
mixing a concentrated bitter wort; a fruit or vegetable juice; and a foam stabiliser to form the non-fermented concentrated beverage formulation of claim 32, wherein the concentrated bitter wort is made using 80% or more malted barley, and wherein the foam stabiliser causes a frothy head to remain on the beverage for at least 2 minutes when poured in a glass.

41. The method of claim 40, further comprising diluting the non-fermented concentrated beverage formulation with water to form a non-fermented beverage.

42. The method of claim 41, further comprising carbonating the non-fermented beverage following the dilution with water.

43. (canceled)

44. (canceled)

45. The method of claim 40, further comprising mixing a foaming agent with the concentrated bitter wort; the fruit or vegetable juice; and the foam stabiliser to form the non-fermented concentrated beverage formulation.

46. A method of making a non-fermented carbonated beverage according to claim 1, the method comprising:
mixing a concentrated bitter wort; a fruit or vegetable juice; and a foam stabiliser to form a concentrated beverage formulation, wherein the concentrated bitter wort is made using 80% or more malted barley, and wherein the foam stabiliser causes a frothy head to remain on the beverage for at least 2 minutes when poured in a glass;
diluting the concentrated beverage formulation with water to form a non-fermented beverage; and
carbonating the non-fermented beverage to form a non-fermented carbonated beverage according to claim 1.

47. A non-fermented concentrated bitter wort also comprising an acidity regulator and/or a foam stabiliser, wherein the concentrated bitter wort is made using 80% or more malted barley.

48. (canceled)

49. (canceled)

50. The concentrated bitter wort of claim 47, further comprising a foaming agent, an antioxidant, and/or ascorbic acid.

51. (canceled)

52. (canceled)
